(19) United States
(12) Patent Application Publication
(10) Pub. No.: US 2023/0048773 A1
(43) Pub. Date: Feb. 16, 2023

(54) TOPLOADER CARD SLEEVE WITH EXTENDED REAR PANEL

(71) Applicant: Ron BURKO, VALLEY STREAM, NY (US)

(72) Inventor: Ron BURKO, VALLEY STREAM, NY (US)

(21) Appl. No.: 17/401,789

(22) Filed: Aug. 13, 2021

(51) Int. Cl. G09F 1/10

(52) U.S. Cl. CPC G09F 1/10

(57) ABSTRACT

A toploader card sleeve with extended rear panel includes relative dimensions particularly devised to house a corresponding collectable card, to surroundingly protect the card, and facilitate insertion and retrieval of the card into and out of a corresponding toploader. The sleeve includes an extended rear panel that presents a top edge spaced apart from the top edge of a front panel. The rear panel top edge facilitates guiding the card into and out of the sleeve and facilitates insertion and retrieval of the sleeve into and out of the toploader.

### BACKGROUND OF THE INVENTION

Various protective covers are seen in the prior art devised to encase and protect collectable cards such as sports cards while enabling display of the card in an unobstructed fashion. Cases having an open slit along a top edge are termed “toploaders,” because the card is inserted and withdrawn through the top of the loader. Toploaders are typically manufactured from transparent plastic or other polymer and are fairly stiff, the idea being to prevent folding (and therefore creasing) of the card therein contained.

Problems arise, however, when placing cards into and withdrawing cards out of toploaders. Sometimes, especially with repeated use, because the toploader is devised of stiff material, the corners of the loaded card may be damaged during insertion, decreasing the value of the card. Further, the need to grasp the top edge of the card when removing the card from the toploader can lead to wear and tear along the top edge, especially due to acidic perspiration through the user's skin.

To solve these problems and prevent such damage, sleeves are typically employed. The card is first placed inside a transparent thin-film sleeve, and then inserted into the toploader. The sleeve encases the card and thus adds a layer of protection, especially with mind to the corners. When inserting the card and sleeve into a toploader, the sleeve first contacts the toploader and any misloading is likely not to impact the card itself. However, the top edge of the card is still inadvertently subjected to unnecessary human contact when removing the card and sleeve from the toploader and inserting the card into the sleeve can still damage the lower edge and corners of the card. What is needed is a toploader card sleeve with extended rear panel that is specifically sized to enable ready grasping of the sleeve for removal from a toploader and which facilitates placing the card into the sleeve without damaging the card's lower edge or corners.

### FIELD OF THE INVENTION

The present invention relates to sleeves for protecting and displaying collectable cards such as sport cards and, more particularly, to a toploader card sleeve with is extended rear panel, and more particularly, to a toploader card sleeve with extended rear panel devised to enable unimpeded insertion of the card into and out of the sleeve while enabling ready retrieval of the card from inside a toploader without a user having to contact the card itself.

### SUMMARY OF THE INVENTION

The present toploader card sleeve with extended rear panel has been devised to ensure facility in inserting collectable cards into and out of toploaders, to protect the cards and enable adequate and unobstructed display.

Toploader sleeves are seen in the art. However, the instant sleeve differs from the state of the art by its particular dimensions devised proportionally to optimize positioning of the card inside an associated toploader and that facilitate insertion of the card into the sleeve without risk of damaging the corners or lower edge of the card. The present toploader sleeve with extended rear panel thereby enables ready retrieval of the card from inside the toploader without the user inadvertently contacting the card's upper edge, as frequently occurs in the state of the art.

The present toploader sleeve with extended rear panel, then, includes a transparent thin-film envelope sized specifically to enclose a card and maintain a space perimetrically surrounding the card edges to present a buffer between the toploader and the card perimeter. Further, the present toploader sleeve with extended rear panel includes an extended rear edge; that is, a top edge of a rear side of the sleeve has a height proportionately longer than the height of the front side of the sleeve. As such, the rear panel protrudes above the sleeve opening, and aligns a top edge proximally with the upper edge of the toploader to present a rear flap thereat. This flap enables retrieval of the sleeve and card as it may be grasped by a user and used to lift the sleeve out of the toploader without the user contacting the top edge of the card contained within the sleeve.

Additionally, and importantly, the extended rear panel facilitates insertion of the card into the sleeve itself. The lower portion of the card is placed atop the flap. The card can thence be inserted into the sleeve without the user having to pinch the sleeve open or otherwise direct the card into a slit opening that has parallel edges. Rather, the extended rear panel serves as a guide for positioning the card against the flap and facilitates opening of the sleeve for guided insertion of the card therein.

The sleeve further protects the card from direct contact with the toploader. Toploaders are typically rendered of relatively stiff plastic. Direct contact with the toploader can scratch, scuff, mar, or otherwise damage the surface of the card. Further, the sleeve is smooth and devised to slide or glide into the toploader and minimize frictional resistance between the card and the toploader as otherwise can result between the glossy paper or card stock of the card relative the polymer or plastic of the toploader. The sleeve further presents a buffer around the card to maintain the card generally centrally displayed interior to the toploader and to protect the card from edgewise contact with the toploader edges.

The instant toploader sleeve with extended rear panel, therefore, comprises specific relative dimensions as set forth herein, which dimensions are devised and enumerated relative to particular card sizes extant on the market and the dimensions of the corresponding toploaders devised for such cards' display. It should be noted that the dimensions claimed herein are therefore set forth relatively in order to accommodate the size relationships already seen in the art.

Thus has been broadly outlined the more important features of the present toploader card sleeve with extended rear panel so that the detailed description thereof that follows may be better understood and in order that the present contribution to the art may be better appreciated.

Objects of the present toploader card sleeve with extended rear panel, along with various novel features that characterize the invention are particularly pointed out in the claims forming a part of this disclosure. For better understanding of the toploader card sleeve with extended rear panel, its operating advantages and specific objects attained by its uses, refer to the accompanying drawings and description.

### BRIEF DESCRIPTION OF THE DRAWINGS

### Figures

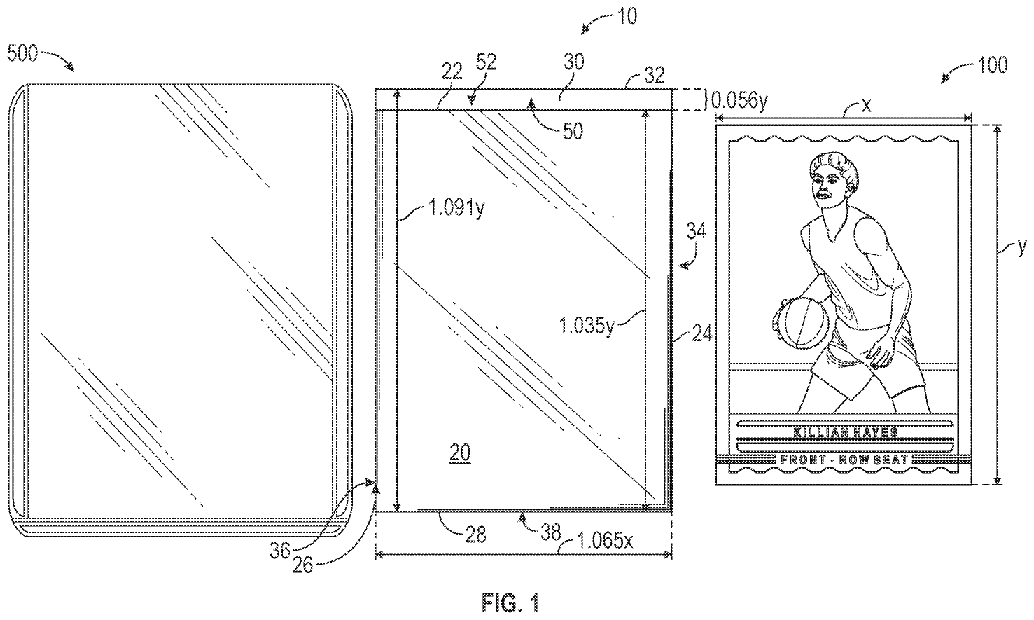

FIG. 1 is a front elevation view of an example embodiment of a toploader card sleeve with extended rear panel with an example embodiment of a sports card and associated toploader.

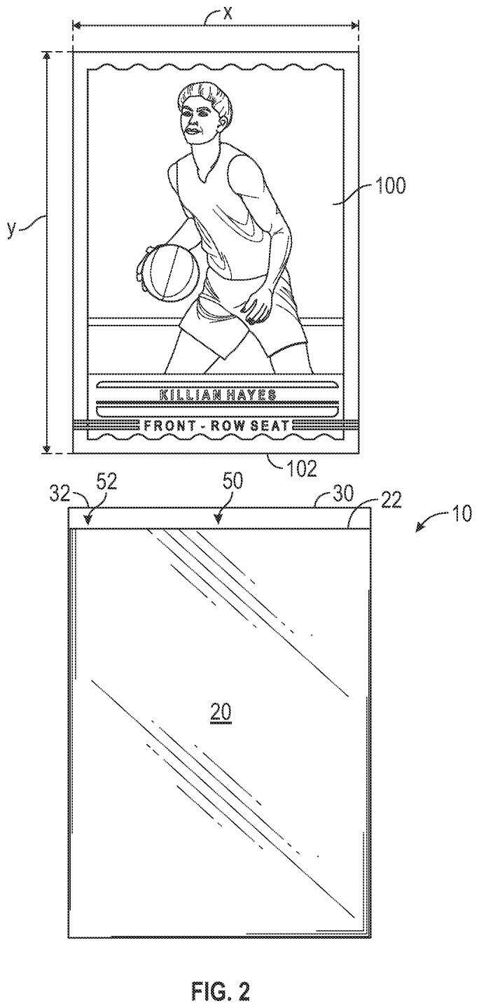

FIG. 2 is a front elevation view of an example embodiment of a sports card ready for insertion into an example embodiment of the toploader card sleeve with extended rear panel.

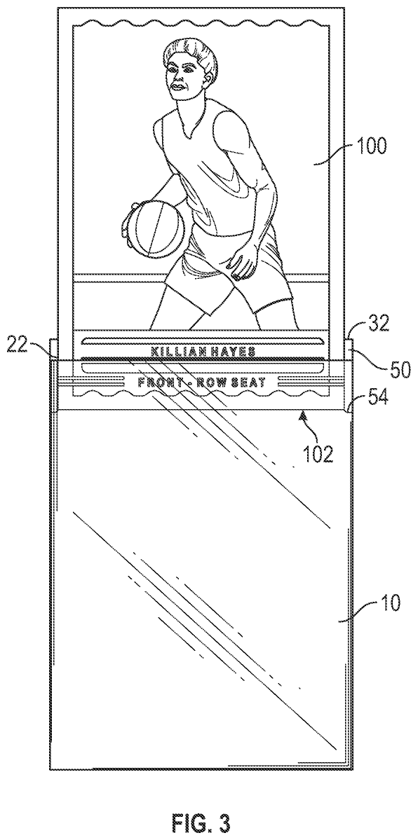

FIG. 3 is a front elevation view of the sports card shown in FIG. 2 being inserted into the toploader card sleeve with extended rear panel, wherein the extended rear panel assists guiding the card into the sleeve and thereby protects the corners and bottom edge of the card.

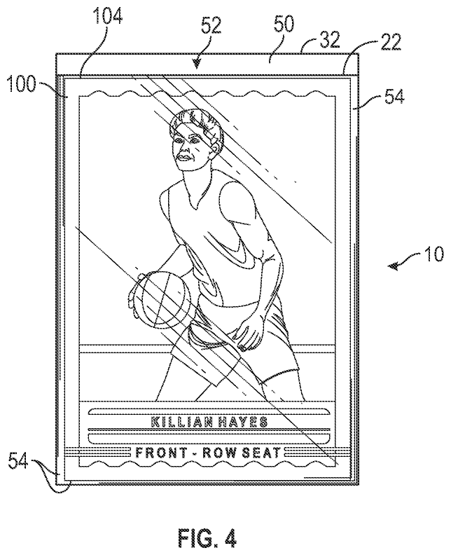

FIG. 4 is a front elevation view of the example embodiment of the sports card of FIG. 3 inserted within the sleeve.

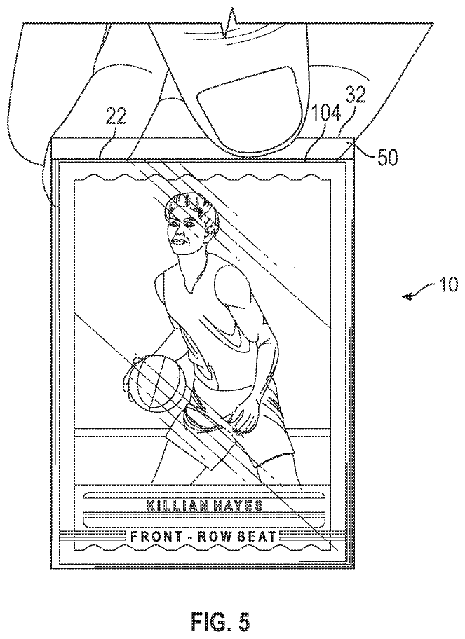

FIG. 5 is a front elevation view of a user handling the example embodiment of the card and sleeve depicted in FIG. 4 by means to the extended rear panel.

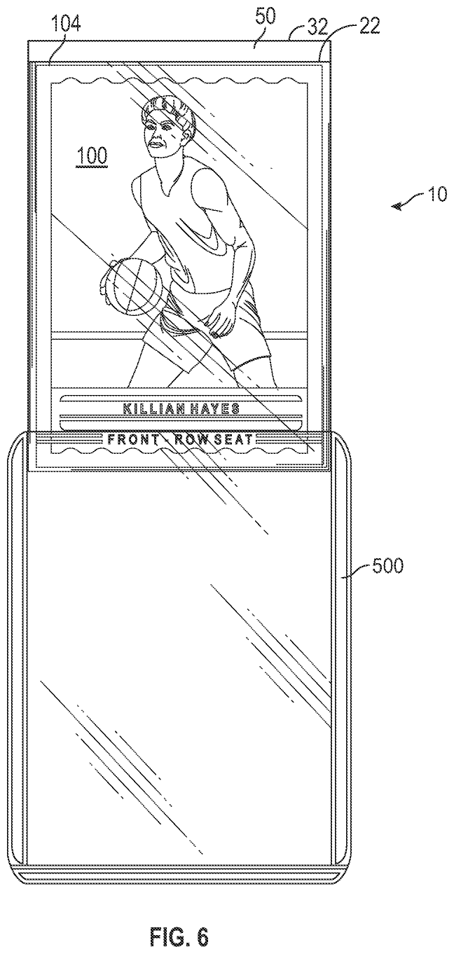

FIG. 6 is a front elevation view of the example embodiment of the sleeve of FIG. 5 assisting guided insertion of the card into a toploader.

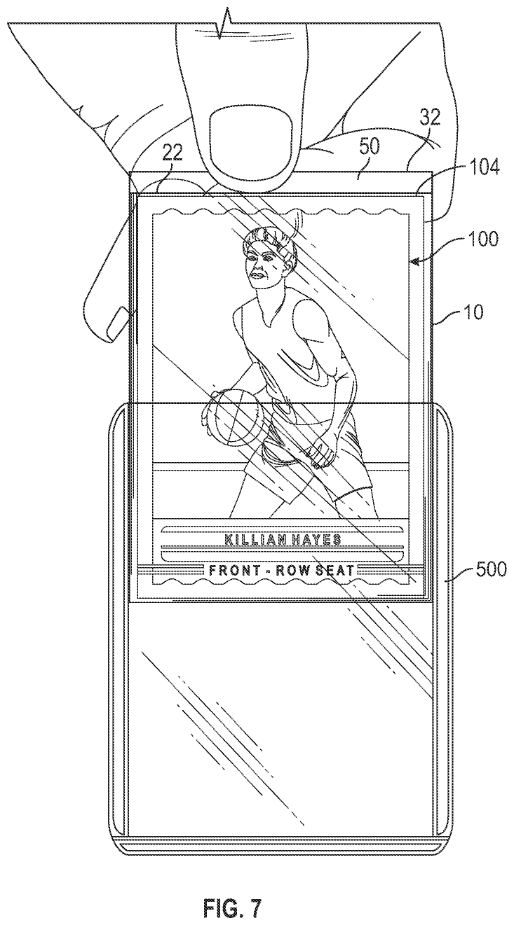

FIG. 7 is a front elevation view of the example embodiment depicted in FIG. 6 2 illustrating a user maneuvering the card in or out of the toploader by means of the extended rear panel.

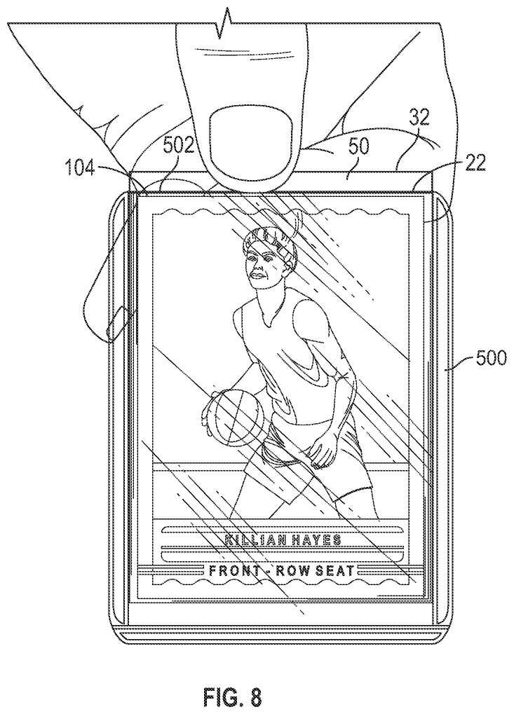

FIG. 8 is a front elevation view of the example embodiment depicted in FIG. 7 wherein the card is nearly fully inserted into the toploader with just the extended rear 6 panel top edge protruding therefrom.

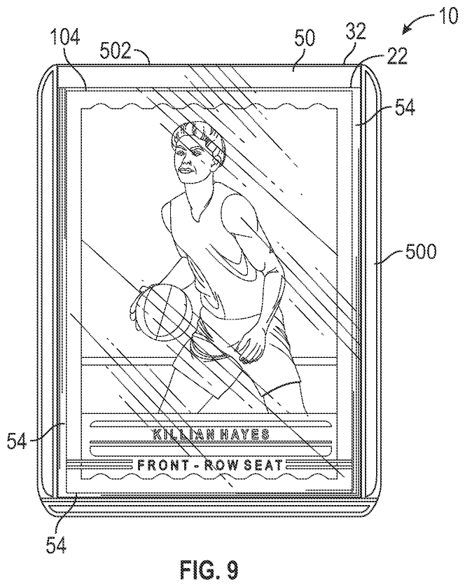

FIG. 9 is a front elevation view of the example embodiment depicted in FIG. 8 with the card and sleeve fully inserted interior to the toploader. The extended rear panel top edge is conjunct or immediately proximal and parallel with the toploader top edge.

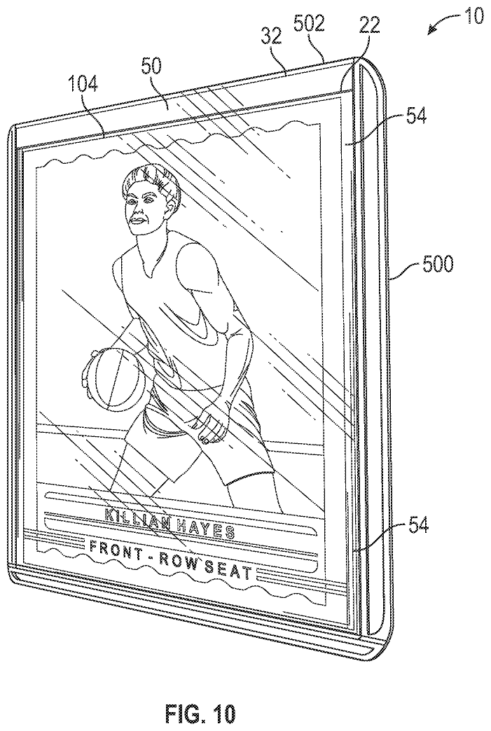

FIG. 10 is a perspective view of the example embodiment depicted in FIG. 9 with the card and sleeve fully inserted interior to the toploader. The extended rear panel top edge is conjunct or immediately proximal and parallel with the toploader top edge.

### DETAILED DESCRIPTION OF THE DRAWINGS

Referring generally to FIGS. 1 through 10, a preferred embodiment of the present toploader card sleeve with extended rear panel 10 is illustrated. Exemplary sports card is approximately 63.5 mm wide and 88.9 mm tall (2.5″×3.5″). Exemplary toploader is approximately 76.2 mm wide by 101.6 mm tall (3″×4″). Exemplary sleeve is approximately 67.6 mm wide by 92 mm tall (2.66″×3.62″). Rear panel of sleeve extends approximately 5 mm (0.2″ or approximately 3/16″) beyond the height of front panel of sleeve and is therefore approximately 67.6 mm wide by 97 mm tall (2.66″ by 3.82″). However, it should be noted that the above dimensions are provided for example only. The present disclosure is directed to relative proportions of the sleeve proper, sized in relation to existing sport cards that are typically sold in standardized dimensions for use with existing toploaders that are in turn produced to house said standardly dimensioned cards. The term “approximately,” as used herein throughout, is taken to allow for between a 2 to 3 mm variation in either direction (or 1/16″ to 2/16″).

Such dimensions as provided above are provided merely for the purposes of illustration; relative dimensions will be set forth herein in relation to an exemplary sports card having width of x units and height of y units. The relative dimensions of sleeve are particularly devised to assist loading a corresponding card into the sleeve while protecting the card edges and corners as well as to facilitate handling of the card once ii inside the sleeve into and out of the associated toploader. Sleeve presents buffer surrounding card once card is inserted therein. Sleeve is clear, transparent, smooth, and does not obstruct or alter display of card therein. In a preferred embodiment, sleeve is clear, soft, smooth, acid-free, PVC-free, polypropylene. Sleeve may be thin-film (e.g. 6.0 μm). Referring now to FIG. 1, existing card 100 has width of x units and height of y units. Sleeve 10 has a front panel 20 having a top edge 22, a first edge 24, a second edge 26, and a bottom edge 28. Front panel 20 is approximately 1.065x units wide and 1.035y units tall. Sleeve 10 has a rear panel 30 having a top edge 32, a first edge 34, a second edge 36, and a bottom edge 38. Rear panel is approximately 1.065x units wide and 1.091y units tall. Front panel 20 is seamlessly joined or fused or heat welded to rear panel 30 at each of the respective first 24, 34, second, 26, 36 and bottom edges 28, 38, whereby top edge 32 of rear panel 30 protrudes above the top edge 22 of the front panel 20 by 0.056y units. Flap 50 is therefore exposed above the sleeve 10 opening 52. Extended rear panel 30 presents flap 50 and facilitates placement of card 100 interior to sleeve 10 to prevent damage to the card 100 during installation within the sleeve 10. Top edge 32 of rear panel 30 facilitates position of the sleeve 10 into and out of the toploader 500 without a user having to directly contact the card 100.

FIG. 2 illustrates exemplary card 100 of width x units and height y units positioned diagrammatically for insertion into sleeve 10 at opening 52. Rear panel 30 presents flap 50 to facilitate insertion of the card 100 without a user abutting the card's 100 lower edge 102 against the top edge 22, 32 of either front or rear panel, 20, 30. FIG. 3 illustrates card 100 partially inserted into sleeve 10. Flap 50 has assisted guiding card 100 lower edge 102 into sleeve 10. Buffer 54 is shown on either side of card 100. FIG. 4 illustrates card 100 fully inserted into sleeve 10. Card 100 top edge 104 is disposed parallel with top edge 22 of sleeve front panel 20. Rear panel 30 top edge 32 presents flap 50 therebove. As shown in FIG. 5, flap 50 is usable to grasp and is handle the card 100 once contained within the sleeve 10. The user does not contact the card 100 upper edge 104 when handling the sleeve 10 flap 50. Sleeve flap 50 also makes retrieval of card 100 from within the sleeve 10 easier; the flap 50 can be grasped to open the sleeve 10 for ready retrieval of the card 100 without the user having to pinch the sleeve 10 or compress the sleeve 10 inward from the side edges 24, 34 and 26, 36. FIG. 6 illustrates the card 100 in the sleeve partially inserted into a corresponding toploader 500. Sleeve 10 protects card 100 and prevents direct contact between the card 100 and the toploader 500. Further, sleeve 10 is smooth and glides into toploader 500 without risk of scraping, scratching, or otherwise marring card 100 surface from contact with toploader 500 interior.

FIG. 7 illustrates a user loading (or unloading) the card 100 from the toploader 500 by grasping the rear panel 30 top edge 32. The user does not directly contact the card 100 upper edge 104, as otherwise frequently occurs with sleeves having front and rear panels of the same height. FIG. 8 illustrates the sleeve 10 fully inserted into the toploader 500 with the exception of flap 50. Flap's 50 protrusion above the toploader 500 upper edges 502 illustrates the facility in maneuvering the card 100 in the sleeve 10 into and out of the toploader 500.

FIGS. 9 and 10 illustrate the card 100 and sleeve 10 inserted into the toploader 500. Rear panel 30 upper edge 32 is disposed in close proximity and in parallel with upper edge 502 of toploader 500. Sleeve 10 surroundingly protects card 100 from direct contact with the toploader 500. Sleeve 10 is sized appropriately to present buffer 54 around the card 100 to prevent edgewise contact or pressure from handling of the toploader 500 and to position the card 100 centrally within the toploader 500 for display. Sleeve 10 is rendered to be barely visible. Flap 50 is nonetheless present to enable ready retrieval of the card 100 from inside the toploader 500 by a user. Flap 50 presents rear panel 30 top edge 32 in immediate proximity to upper edge 502 of toploader 500 for grasping. Because rear panel 30 top edge 32 protrudes at least 0.056y above front panel 20 top edge 22, opening the sleeve 10 is facilitated for easy removal of card 100 from inside sleeve 10.

What is claimed is:

1. A toploader card sleeve with extended rear edge, said sleeve sized to accommodate an existing card and then fit interior to an existing toploader to protect the card and present the card for view, said sleeve comprising:
a front panel having a top edge, a first edge, a second edge, and a bottom edge; and
a rear panel seamlessly attached to the front panel along the first, second, and bottom edges, said rear panel approximately 5.44% taller that the front panel;
wherein the rear panel presents a top edge spaced apart from and parallel with the top edge of the front panel to a position extended approximately 5.15% of the length of the rear panel.

2. The toploader sleeve with extended rear edge of claim 1 wherein the front and rear panels are approximately 6.5% wider than the extant card with which the sleeve is devised for use.

3. The toploader sleeve with extended rear edge of claim 2 wherein the front panel is approximately 3.5% taller than the extant card.

4. The toploader sleeve with extended rear edge of claim 3 wherein the rear panel is approximately 9.11% taller than the extant card.

5. A toploader card sleeve with extended rear edge, said sleeve sized to accommodate an existing card that is x units wide and y units long, said sleeve fittable interior to an existing toploader to surroundingly protect the card and present the card for view, said sleeve comprising:
a front panel having a top edge, a first edge, a second edge, and a bottom edge, said front panel approximately 1.065x units wide and 1.035y units tall; and
a rear panel having a top edge, a left edge, a bottom edge, and a right edge, said rear panel approximately 1.065x units wide and 1.091y units tall;
wherein the front panel is seamlessly joined to the rear panel at each of the respective first, second, and bottom edges whereby the top edge of the rear panel protrudes above the top edge of the front panel and facilitates placement of the card interior to the sleeve to prevent damage to the card during installation within the sleeve and whereby the top edge of the rear panel facilitates position of the sleeve into and out of the toploader without a user having to directly contact the card.

6. The toploader card sleeve with extended rear edge of claim 5 wherein the card is surrounded by the sleeve and positions centrally interior to the sleeve when the sleeve is inserted into the toploader so that the card is framed by the toploader and the corners of the card are protected as the sleeve is inserted into the toploader.
